(19) United States
(12) Patent Application Publication
(10) Pub. No.: US 2009/0237418 A1
(43) Pub. Date: Sep. 24, 2009

(54) USEABILITY FEATURES IN ON-LINE DELIVERY OF APPLICATIONS

(75) Inventors: Itay Nave, Kfar Hess (IL); Ohad Sheory, Neve-Monosson (IL)

Correspondence Address: FIALA & WEAVER, P.L.L.C.;C/O CPA GLOBAL, P.O. BOX 52050, MINNEAPOLIS, MN, 55402, US

(73) Assignee: EXENT TECHNOLOGIES, LTD., Petach-Tikva (IL)

(21) Appl. No.: 12/479,326

(22) Filed: Jun. 5, 2009

Related U.S. Application Data
(63) Continuation of application No. 10/851,643, filed on May 24, 2004.
Application No. 10/851,643 is a continuation of application No. 10/735,483, filed on Dec. 12, 2003.
Application No. 10/735,483 is a continuation-in-part of application No. 10/616,507, filed on Jul. 10, 2003, now abandoned.
Application No. 10/616,507 is a continuation of application No. 09/866,509, filed on May 25, 2001, now Pat. No. 6,598,125.
(60) Provisional application No. 60/207,125, filed on May 25, 2000.

(51) Int. Cl. G09G 5/00; G06F 9/44; G06Q 30/00

(52) U.S. Cl. 345/629; 719/328; 705/14

(57) ABSTRACT

Systems, methods, and computer program products for enhancing useability of on-line delivered applications. Access control is provided by generating and delivering an activation key to a client whenever the client seeks access to an application. A security process, integral to the application, validates the key. With respect to displaying information, a client inserts itself between the application and the renderer. This allows the client to provide information to the renderer for display to the user.

### CROSS-REFERENCE TO RELATED APPLICATIONS

This application is a continuation of U.S. patent application Ser. No. 10/851,643, filed May 24, 2004, which is a continuation of U.S. patent application Ser. No. 10/735,483, filed Dec. 16, 2003, which is a continuation in part of U.S. patent application Ser. No. 10/616,507, filed Jul. 10, 2003, which is a continuation of U.S. patent application Ser. No. 09/866,509, filed May 25, 2001, which claims priority to U.S. Provisional Patent Application No. 60/207,125, filed May 25, 2000. All of these applications are incorporated by reference in their entireties.

### BACKGROUND OF THE INVENTION

1. Field of the Invention

This technology relates generally to delivery of applications across a network.

2. Related Art

The delivery of an applications from a server to client across a network has become commonplace. Examples of such applications include utilities, games, and productivity applications. Nonetheless, the delivery process is not necessarily convenient. Considerable amounts of data need to be transferred for the complete delivery of an application, and a complete download may take hours in some circumstances. This may be followed by a cumbersome installation process. Moreover, such transactions may be further complicated by security considerations. A user may need to be authenticated, for example. In general, from the user perspective, there is a need to shorten and simplify the process of accessing an application online.

A common problem in the distribution of software is the management of digital rights and the threat of piracy. Ideally, from the point of view of the vendor, a software package would be sold to a buyer, and that buyer would be the only party licensed to use the software. Unlicensed use of the software, i.e. pirating, obviously represents a financial loss to the software vendor. Currently, when a vendor sells certain software titles in the retail environment, the user is requested in many cases to enter a code, typically printed on the back of the packaging during the installation process. This effectively marks the installation and links it to a unique key. This is a valid key that can be used in conjunction with this copy of the software title. Typically, the software would access a central server to validate the key and the registration. This code can be thought of as a CD key.

Obviously, such a mechanism cannot be used in the on-line distribution of an application. In such a transaction there is no packaging and there is no CD key presented to the user. Also, distributing keys over the internet and exposing or sending the keys to the user is not convenient and not secure.

Digital rights management is also an issue in the use of software in an enterprise, such as a corporate or government organization. A company may wish to have some number of licenses to run an application on each of several computers. One solution to managing access to the application is to obtain keys, analogous to the CD keys above, that represent licenses to use the application. If the application is delivered to the organization on-line, the delivery of keys can be problematic, since there is no physical distribution channel. Moreover, lawful use of the application by the organization requires not only obtaining keys, but tracking both the number of keys in use and the parties using them. Keys must be allocated only to authorized parties. Any attempt to use the application without a valid key must be prevented.

Hence there is a need for a system and method by which access to an application can be controlled, given that the application is delivered over a network. A mechanism for the distribution of keys is needed, along with a mechanism for allocating the keys and controlling their use. Also, there is a need to track the usage of keys in order to prevent their loss. Today, an enterprise may buy some number of keys and install them manually on each computer. The system administrator has to manually track the keys and make sure that before buying more keys, he has used all the previously purchased keys. Large organizations may find it hard to track the registration of keys especially as new employees are joining the organization and others leave.

Another issue with respect to on-line delivered applications is the passing of status and other information to the user, where this information may be ancillary to the application itself. Given an application program that has been delivered to a client, the client obviously has an expectation that the application work as desired, and that all necessary information presented by the application is available to the user. There may be times, however, where information must be conveyed to the user, apart from what is normally conveyed during the execution of the application. For example, status information may need to be conveyed to a user while the application runs. In particular, there may be times when additional data needs to be downloaded to the user from the server. Such a download can take an extended period. During this interval, the user needs to know that the download process is taking place. It may also be required that other status or alert messages be conveyed to the user. In addition, the user may desire to see help messages that explain particular options or functions to the user. In some settings, it may be desirable to present advertising to a user. All such information needs to be presented to a user in a clear manner, while minimizing the extent of the intrusion on the user's experience with the application.

One solution to this might be to open a separate window for a user and display the information in this second window, while the application continues to run in the initial window. However, a user may find this to be disruptive. The users view of the existing application may be diminished. Another alternative might be to halt execution of the application while such messages are presented to the user. This, however, is even more disruptive. The user effectively loses access to his application. Any ongoing processing is simply halted.

What is needed, therefore, is a system and method for communicating to a user status and other information, without disrupting the users experience in running an application.

Another problem that arises in the on-line distribution of applications is that of upgrading or downgrading previously distributed applications. Such modifications may be desirable for a number of reasons. A program may have been improved for purposes of speed and efficiency, or to provide additional content or functionality. A program may also be modified to accommodate a new standard or operating system. A patch may also have to be issued to protect a user against a security flaw or to fix bugs.

One method of modifying an application would be to download a new version of the entire application. This is not practical for a number of reasons. First, a complete download would take an inordinate amount of time and memory. Moreover, a complete download of the upgraded or downgraded application might be redundant. Such modifications are not necessarily comprehensive and may only address small portions of content. Transfer of anything more than the modified portions would be unnecessary. Another option is to download and install a patch. This is not convenient because the end user has to wait for the download and then go through an install process replacing all the upgraded or downgraded files. The process may be long and in some cases may require a computer reboot.

In addition, some of the previously downloaded components of the application may have been modified by a user. Such modifications may have been made in order to accommodate a user's selected settings, for example. A comprehensive download might overwrite such settings.

The problems in upgrading or downgrading an application are multiplied in an enterprise setting. Here, multiple users must be upgraded either manually or through a network. In either case, considerable time and effort may be required, given that the upgrade or downgrade becomes an organization-wide task.

Hence there is also a need for a fast and convenient method and system for the distribution of application modifications on-line, such that the user or organization is transparently given the necessary upgrades or downgrades without losing his previously implemented settings.

The rate of on-line delivery of an application to a client can also be problematic, given the amount of information to be transferred. A client computer requires blocks of information for the content to operate properly. The blocks of information can come from different data sources, such as a compact disk (CD), a DVD, or from another computer such as a file server networked with the client. The client computer can be connected to the file server by a local network (LAN) or a wide area network (WAN), such as the Internet.

Generally, content must be installed on a client computer before it can be executed. It is generally installed from a data source, such as those listed above. During the installation process, files of a certain size that are frequently required for operation of the content are copied to the hard drive of the client computer. From there they are readily accessible. Since the hard drive of the client computer is generally limited in storage capacity, some of the large content files may not be copied to it. These large files could comprise, for example, video files, large executable files, data files, or dynamic link libraries. When they are needed these large content files must then be retrieved from the data source, which may have a slower retrieval time. Alternatively, if only a portion of a large content file is to be used, the blocks of information representing this portion of the file can be cached on the hard drive of the client computer.

After installation, a work session can be started to commence use of the content. During the session additional blocks of information are required. Some blocks of information are used more frequently than other blocks. The blocks of information can be obtained directly from the data source of the content if it is still available during the work session, although access times to this information are generally constrained. The slow response times are generally caused by the various technical and hardware limitations of the data source being used.

Conversely, the access time to blocks of information stored on the hard drive of a client computer is comparatively fast. However, the hard drive of a client computer possesses only limited storage capacity. For these reasons, the hard drive of the client computer is the preferred storage location for blocks of frequently accessed information that are of manageable size.

To reduce the impact of these limitations, various caching methods are used to optimize accessibility to the blocks of information required by the content of an active work session. A certain amount of storage space is set aside on the hard drive of the client computer for each content. As the content is used, blocks of information brought to the client computer from the data source are temporarily stored (cached) in this allocated space on the hard drive. As the space fills and new information needs to be stored, the least used information is discarded to make room for the new. By this means, faster repeated access can be provided to blocks of information that have been most used. Ultimately, when the session using this content is completed, the allocated space that was used on the hard drive is made available for use for other purposes. Unfortunately, the next time a work session is commenced for the same content, the blocks of information that had been cached are no longer available and need to be obtained again from the data source. This results in inefficiency and delays, and diminishes the overall experience of the operator of the client computer.

Therefore, what is further needed is an improved method of caching blocks of information on a local client computer that reduces information transfer requirements from the data source, thereby improving the responsiveness of the client computer.

### SUMMARY OF THE INVENTION

The present invention solves the access control problem by generating and delivering an activation key to a client whenever the client seeks access to an application. In general, once the user selects an application, a system database either identifies an activation key to be associated with the user or his client machine, or sends an activation key that was previously associated with the user or client machine. This activation key is then sent to a vendor server. The vendor server forwards the activation key to client. Before the client executes the application, the client stores the activation key in a manner and location specified by the application. A security process may then take place integral to the application, in order to validate the activation key.

With respect to displaying information to the user, a renderer presents information to a user, where an application such as a game is being executed. Through the connection between the application and the renderer, the renderer receives data and commands from the application. The output of the renderer is then sent to a display. Here the user is shown the images presented by the application, allowing the user to provide input as necessary. The invention provides a system and method by which a client can effectively insert itself between the application and the renderer. This allows the client to provide information to the renderer, such as text and graphics, for display to the user. The provided information is overlaid on the normal application display.

Content can be upgraded or downgraded as follows. Given an application, any associated files that contain blocks updated locally at the client are moved to a static cache. The corresponding files are deleted from a dynamic cache. The client receives a change log from the application server. The change log represents a list of blocks that have been changed at the application server as a result of the upgrade. The client then copies any locally updated or new files from the static cache to a backup directory. The client then clears the static cache.

The client then deletes blocks from the dynamic cache. In particular, the client deletes those blocks that correspond to the blocks identified in the change log. The client loads the locally updated or new files from the backup directory back to the static cache. The client then downloads upgraded blocks from the application server, as needed.

The invention also provides for the efficient caching of blocks of information in persistent memory of a client computer. One embodiment of the invention features a Least Recently Least Frequently Used (LRLFU) method for efficient caching, performed by a cache control module executing on the client. Blocks in the client's cache are sequenced according to a calculated discard priority. The discard priority of a cached block depends on the most recent usage of the block and it's frequency of usage. Newly downloaded blocks are cached if space is available. If space is not available, previously cached blocks are discarded until sufficient space is available. A block(s) is chosen for discarding on the basis of its discard priority.

Further embodiments, features, and advantages of the present invention, as well as the structure and operation of the various embodiments of the present invention, are described below with reference to the accompanying drawings.

### BRIEF DESCRIPTION OF THE FIGURES

These and other features of the invention are more fully described below in the detailed description and accompanying drawings.

FIG. 1 is a block diagram illustrating a system for the on-line delivery of application programs to a client.

FIG. 2 is a flowchart generally illustrating the method of issuing an activation key to a client, according to an embodiment of the invention.

FIG. 3 is a flowchart illustrating the process of validating an activation key, according to an embodiment of the invention.

FIG. 4 illustrates the allocation of activation keys to applications in a data structure, according to an embodiment of the invention.

FIG. 5 is a block diagram illustrating the interjection of an information object by a client to a renderer, according to an embodiment of this invention.

FIG. 6 is a flow chart illustrating the process of obtaining and maintaining a handle to an application programming interface, according to an embodiment of this invention.

FIG. 7 illustrates the organization of data representing an application image, according to an embodiment of the invention.

FIG. 8 is a flowchart illustrating the process of upgrading an application from the perspective of an application server, according to an embodiment of the invention.

FIG. 9 is a flowchart illustrating the process of upgrading an application from the perspective of a client, according to an embodiment of the invention.

FIG. 10 is a block diagram illustrating the process of transmitting an upgraded file from a dynamic cache to a static cache, according to an embodiment of the invention.

FIG. 11 is a block diagram illustrating the process of sending a change log to a client, according to an embodiment of the invention.

FIG. 12 is a block diagram illustrating the process of moving a file to a backup directory, according to an embodiment of the invention.

FIG. 13 is a block diagram illustrating a dynamic cache modified after receipt of a change log, according to an embodiment of the invention.

FIG. 14 is a block diagram illustrating the process of reloading a file from the backup directory to the static cache, according to an embodiment of the invention.

FIG. 15 is a block diagram illustrating the process of receiving upgraded blocks of an application image from an application server, according to an embodiment of the invention.

FIG. 16 is a flow chart illustrating the sequence of steps used to cache a block of information, according to an embodiment of this invention.

FIG. 17 is a block diagram illustrating a system for supporting disk caching at a client, according to an embodiment of this invention.

FIG. 18 is a block diagram illustrating the computing context of the invention.

### DETAILED DESCRIPTION OF THE INVENTION

A preferred embodiment of the present invention is now described with reference to the figures, where like reference numbers indicate identical or functionally similar elements. Also in the figures, the left-most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

Table of Contents
I. System overview
II. Activation key
III. Information overlay
IV. Content upgrade
V. Disk caching
VI. Computing environment
VII. Conclusion

### I. System Overview

The present invention relates to the distribution of software applications over a network, such as the Internet, to a client computer (hereafter, “client”). The invention permits the transfer of the application and related information to take place quickly, efficiently, and with minimal inconvenience to the user. Thus, the experience of the user with the software content is not affected by the fact that delivery of the application takes place across a network.

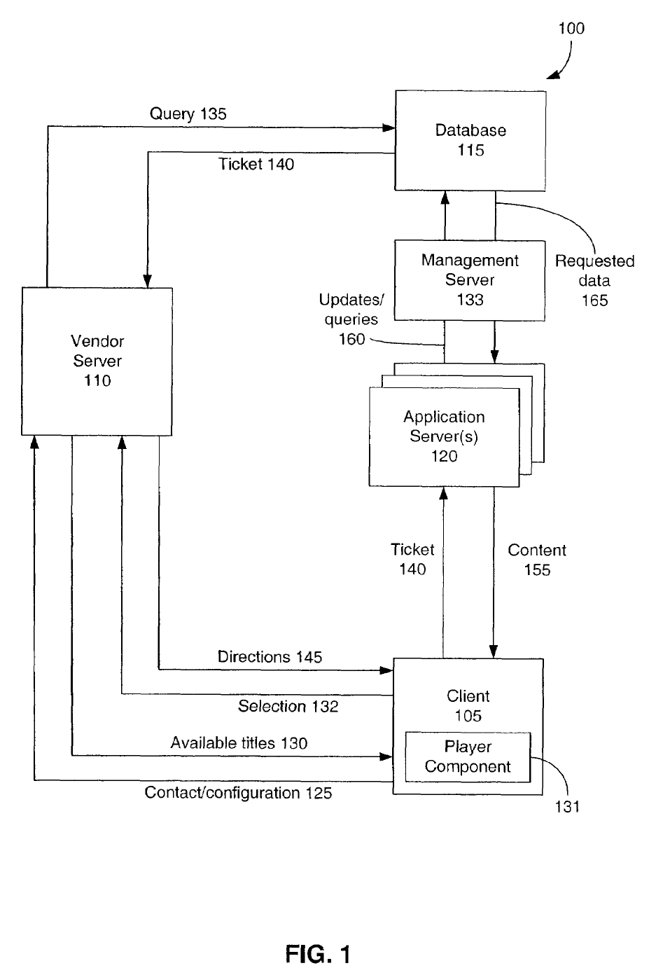

Referring to FIG. 1, a system for allowing streaming of software content includes a client machine 105, a vendor server 110, a database 115, at least one application server 120. In an embodiment of the invention, a management server 133 is also provided. The vendor server 110 and management server 133 share access to the database 115. The client includes a player software component 131 installed prior to the start of a session. The player 131 controls the client interactions with the application server 120. The player 131 is installed on the client 105 only once. Thus, if the user previously installed the player 131 in an earlier session, there is no need to reload the player 131. The vendor server 110 hosts a web site from which the user can select one or more software applications (i.e., titles) for execution.

The application server 120 stores the contents of various titles. Multiple application servers 120 may be utilized to permit load balancing and redundancy, reduce the required file server network bandwidth, and provide access to a large number of contents and software titles. The management server 133 communicates with the application server 120 to receive information on current sessions and communicates with the database 115 to log information on the current sessions. The management server 133 functions as an intermediate buffer between the application server 120 and the database 115, and may implement such functions as load management, security functions and performance enhancements.

The database 115 catalogs the address(es) of the application server(s) 120 for each offered title and logs the user's session data as the data is reported from the management server 133. The database 115 coordinates load management functions and identifies an application file server 120 for the current transaction.

The user starts the session at the client 105 by visiting a web page hosted by the vendor server 110. The communication between the client 105 and the vendor server 110 can be enabled by a browser such as Internet Explorer or Netscape using the hypertext transfer protocol (http), for example. A variety of titles cataloged in the database 115 are offered on the web page for client execution. If the player 131 has been installed on the client 105, a plugin (in the case of Netscape) or ActiveX Control (in the case of Explorer) on the client 105 identifies the hardware and software configuration of the client 105. Hence the initial contact from the client 105 to vendor server 110 is shown as communication 125. The vendor server 110 compares the identified configuration to the requirements (stored on the database 115) of the applications being offered for usage such as rental. The user's browser can display which titles 130 are compatible with the client's configuration. In an embodiment of the invention, noncompatible titles can also be displayed, along with their hardware and/or software requirements.

The user selects a title through an affirmative action on the web page (e.g., clicking a button or a link), shown as communication 132. In response, the vendor server 110 calls a Java Bean that is installed on the vendor server 110 to request information stored on the database 115. This request is shown as query 135. The requested information includes which application server 120 stores the title and which application server 120 is preferable for the current user (based on, for example, load conditions and established business rules). The database 115 sends this requested information (i.e., a ticket 140) back to the vendor server 110, which, in turn, passes the ticket 140 and additional information to the client 105 in the form of directions 145. The ticket 140 may contain multiple parameters, such as the user identity and information about the rental contract, or agreement, (e.g., ticket issue time (minutes) and expiration time (hours)) previously selected by the user in the web site. The ticket 140, created by the Java Bean using information in the database 115, is encrypted with a key that is shared between the Java Bean and the application server 120. The directions include the ticket 140 and additional information from the database 115 that is needed to use the application and to activate the player 131. The directions 145 may also include an expiration time that is contained in the ticket. The Java Bean creates the directions 145 using information in the database 115. The directions 145 can be encrypted with a static key that is shared between the Java Bean and the client 105, and are protected using an algorithm such as the MD5 message digest algorithm.

After the directions 145 are passed from the vendor server 110 to the client 105, no additional communication occurs between the client 105 and the vendor server 110—the player 131 only communicates with the application server 120 for the rest of the session. The client 105 may post error notifications to the vendor server 110 for logging and support purposes. Receipt of the ticket 145 by the client 105 causes the player 131 to initialize and read the directions 145. In an embodiment of the invention, the browser downloads the directions 145, or gets the directions 145 as part of the HTML response. The browser then calls an ActiveX/Plugin function with the directions 145 as a parameter. The ActiveX/Plugin saves the directions 145 as a temporary file and executes the Player 131, passing the file path of the directions 145 as a parameter. The directions 145 tell the player 131 which application has been requested, provide the address of the application server 120 for retrieval, and identify the software and hardware requirements needed for the client 105 to launch the selected content. Also, directions 145 include additional information, such as the amount of software content to be cached before starting execution of the selected title. Additional information can also be included. If the client 105 lacks the software and hardware requirements, or if the operating system of the client 105 is not compatible with the selected title, the client 105 displays a warning to the user; otherwise the transaction is allowed to continue.

The player 131 initiates a session with the specified application server 120 by providing the ticket 140 in encrypted form to the application server 120 for validation. If the validation fails, an error indication is returned to the player 131, otherwise the player 131 is permitted to connect to the application server 120 to receive the requested software content. In response to the player 131's initiation of the session, the application server 120 provides information, including encrypted data, to the client 105. This initialization information includes a decryption key, emulation registry data (i.e., hive data) for locally caching on the client 105, and a portion of the software content that must be cached, or “preloaded”, before execution can start. Emulation registry data is described in U.S. patent application Ser. No. 09/528,582, filed Mar. 20, 2000, and incorporated herein by reference in its entirety.

Note that if the network connection to application server 120 fails, the directions may contain addresses of additional application servers that hold the requested titles, so that the player 131 may then connect to them. As well, the player 131 may be configured to communicate to the application server 120 or an alternative application server via a proxy server (not shown). In addition, the player can reconnect to the same application server in case of temporary network disconnection. A proxy server configuration can be taken from the hosting operating system settings, or client specific settings. For example, the settings can be taken from the local browser proxy server. In a proxy environment, the client can try to connect through the proxy, or directly to the application server.

After initialization is completed and execution begins, additional encrypted content blocks are streamed to the client 105 in a background process. The player 131 decrypts the streamed content using the decryption key provided by the application server 120 in the initialization procedure. Part of the software content is loaded into a first virtual drive in client 105 for read and write access during execution. The other software content is loaded into a second virtual drive, if required by the content, in client 105 for read only access. During execution of the software content, the player 131 intercepts requests to the client 105's native registry and redirects the requests to the emulation registry data, or hive data, the emulation registry data allows the software content to be executed as if all the registry data were stored in the native registry. As the session proceeds, the application server 120 sends information to the management server 133 to be logged in the database 115. The application server 120 continues to write to the management server 133 as changes to the state of the current session occur.

The player 131 executes a predictive algorithm during the streaming process to ensure that the necessary content data is preloaded in local cache prior to its required execution. As execution of the title progresses, the sequence of the content blocks requested by the client 105 changes in response to the user interaction with the executing content (e.g. according to the data blocks requested by the application). Consequently, the provision of the content blocks meets or exceeds the “just in time” requirements of the user's session. Player 131 requests to the application server 120 for immediate streaming of specified portions of the content blocks immediately required for execution at the client 105 are substantially eliminated. Accordingly, the user cannot distinguish the streamed session from a session based on a local software installation.

After the user has completed title execution, the player 131 terminates communication with the application server 120. Software content streamed to the client 105 during the session remains in the client cache of client 105, following a cache discarding algorithm (described in greater detail below). The virtual drives are dismounted (i.e., disconnected), however. Thus the streamed software content is inaccessible to the user. In addition, the link between the emulation registry data in cache and the client 105's native registry is broken. Consequently, the client 105 is unable to execute the selected title after session termination even though software content data is not removed from the client 105.

In an optional feature, during the session, the player 131 periodically (e.g., every few minutes) calls a “renew function” to the application server 120 to generate a connection identifier. If the network connection between the player 131 and the application server 120 is disrupted, the player 131 can reconnect to the application server 120 during a limited period of time using the connection identifier. The connection identifier is used only to recover from brief network disconnections. The connection identifier includes (1) the expiration time to limit the time for reconnecting, and (2) the application server identification to ensure the client 105 can connect only to the current application server or group of servers 120. The connection identifier is encrypted using a key known only to the application server(s) 120, because the application server(s) 120 is the only device that uses the connection identifier.

In another optional feature, the management server 133 verifies the validity of the session. If an invalid session is identified according to the session logging the application server 120, a flag is added to a table of database 115 to signal that a specific session is not valid. From time to time, the application server 120 requests information from the management server 133 pertaining to the events that are relevant to the current sessions. If an invalid event is detected, the application server 120 disconnects the corresponding session. The delayed authentication feature permits authentication without reducing performance of the executing software content.

For illustrative purposes, the foregoing has been described with reference to particular implementation examples, such as Explorer, Netscape, Java, ActiveX, etc. Such references are provided as examples only, and are not limiting. The invention is not restricted to these particular examples, but instead may be implemented using any applications, techniques, procedures, tools, and/or software appropriate to achieve the functionality described herein.

### II. Activation Key

The present invention solves the access control problem by generating and delivering an activation key to a client 105 whenever the client 105 seeks access to an application. In general, once the user selects an application, a system database 115 either identifies an activation key to be associated with the user or his client machine 105, or sends an activation key that was previously associated with the user or client machine 105. This activation key is data that is then sent to a vendor server 110. The vendor server 110 forwards the activation key to client 105 as part of directions 145.

Before the client 105 executes the application, the client 105 stores the activation key in a manner and location specified by the application. A security process may then take place integral to the application, in order to validate the activation key. For example, a determination may be made as to whether the activation key maps to identification information of the client 105 or the user. In an embodiment of the invention, this identification information represents the user's ID. In an alternative embodiment, this identification information represents the client machine 105's ID. If the database 115 indicates that this activation key is in fact associated with the identification information, then the application can then proceed to run at the client.

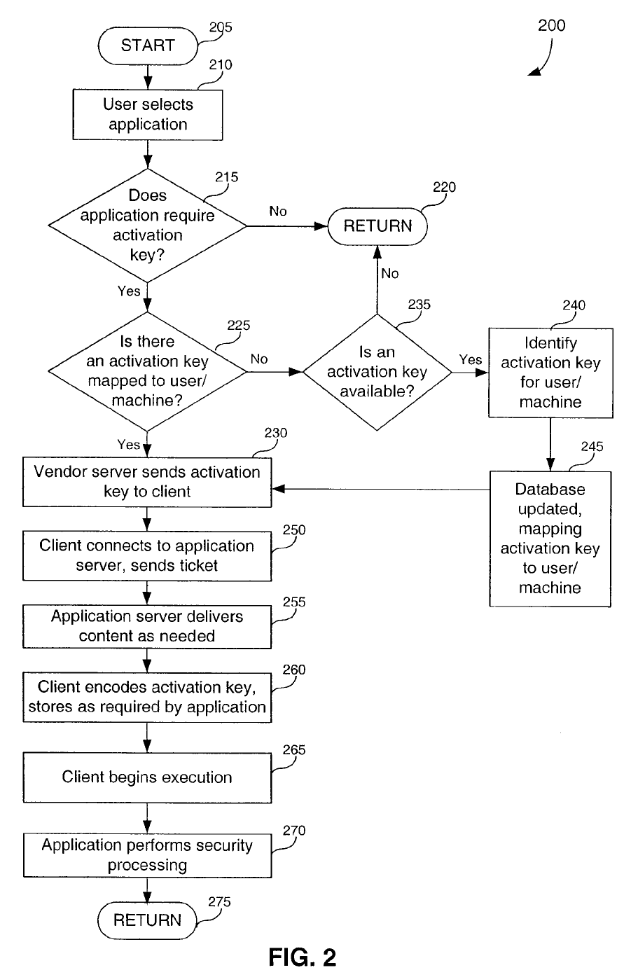

This process is illustrated more specifically in FIG. 2. The process begins at step 205. In step 210, a user at a client machine 105 selects the application desired.

In step 215, a determination is made at the vender server 110 as to whether the selected application requires an application key. While some applications will require an activation key in order to allow client 105 access to the application, other applications may not require an activation key. If no activation key is required, as determined in step 215, client 105 is free to access the application, and the process concludes. If, however, an activation key is required then the process continues to step 225. Here, a determination is made as to whether there is already an activation key mapped to identification information that is associated with the user or client 105. If so, then the process continues to step 230, where the vendor server 110 sends an activation key to client 105.

If there is no activation key currently mapped to the user or client 105, then the process continues at step 235. Here, a determination is made as to whether an activation key is available for the desired application. Database 115 maintains a pool of activation keys associated with each application. If all activation keys are currently allocated to existing clients, then there would be no activation key available for client 105. In this case, access to the desired application may be denied, because no activation key is available for client 105. Alternatively, the client 105 will be allowed to use the application, but with limited functionality. The process would conclude at step 220.

If a valid activation key is available, the process continues at step 240. Here, database 115 identifies an activation key for the user or client 105. In step 245, the database 115 is updated accordingly, to show the mapping between the identified activation key and the user or machine. In step 230, vendor server 110 sends an activation key to client 105.

In step 250, client 105 connects to application server 120, and provides ticket 140 to application server 120. In step 255, application server 120 delivers content to client 105 as needed. Here, the delivered content represents instructions and/or data that enables client 105 to execute the selected application. Note that in some cases, client 105 will already have sufficient content to allow it to begin execution of the chosen application. In this case, client 105 would not need to request any additional content from application server 120. Note that the sequence of steps 250 and 255 represents an example of what can happen when a client 105 receives a key. Different processing is also possible. For example, having the activation key may allow client 105 to run a locally installed application.

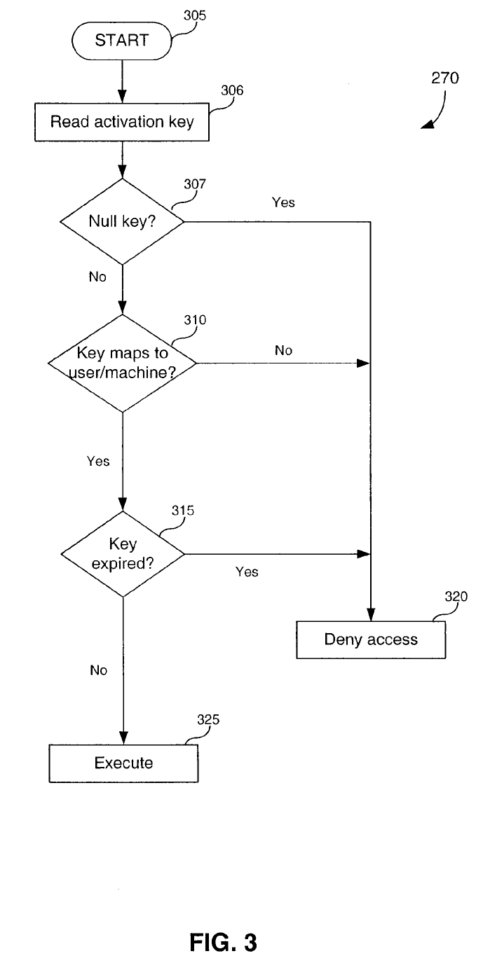

In step 260, client 105 encodes the activation key, and stores the application key as required by the application. Note that the location and manner of storage of the activation key is dictated by the application. Note also that in an alternative embodiment of the invention, the application key may be encoded on the server side, such that the activation key is delivered to client 105 in encoded form. Encoding, in general, provides for secure storage and/or transmission of the activation key. This provides a layer of security that would prevent unauthorized parties from being able to use or distribute the activation key. In step 265, client 105 begins execution of the application. In step 270, the application performs security processing involving the activation key. Such security processing can take a number of forms that are discussed below with respect to FIG. 3. The process concludes at step 275.

One example of the security processing of step 270 is illustrated in FIG. 3. Note that the manner in which security processing is performed is specific to the particular application and is executed by the application itself without any processing by the player 131. The process of FIG. 3 is provided as an example. The process starts at step 305. In step 306, the activation key is read and decoded as necessary. In step 307, a determination is made as to whether the read data exists or not, i.e., access to the application is to be denied. In an embodiment of the invention, a null key can be issued to client 105, thereby permitting the system to immediately deny access to a particular user or machine. Attempts to use such activation key results in access to the application being denied. Any attempt to use the null activation key results in a determination that the activation key is invalid. If the key is determined to be null, then access is denied in step 320. If the key is determined not to be null, then the process continues at step 310. This determination can be made by the application executing on the client machine 105 or by accessing another server and providing it with the key and any other required information.

At step 310, a determination is made as to whether the activation key maps to the user or machine presently holding the activation key. This correspondence would have to be verified by consulting a data structure that maintains the active correspondences, such as database 115. If it is determined in step 310 that the activation key does not map to the user or machine presently holding the activation key, then access is denied in step 320. In such a case, the user or machine may have illicitly obtained an activation key. This would represent an attempt to gain unauthorized access to the application. Likewise, if it is determined that the activation key was used by another user or machine, then access is denied in step 320. If the mapping of the activation key to the user or machine is verified in step 310, then the process continues to step 315.

In step 315, a determination is made as to whether the activation key has expired. In an embodiment of the invention, the activation key may be mapped to a time interval, such that the activation key cannot be used after a predetermined point in time. At that point, the activation key has expired and the key could no longer be used. The application therefore cannot be executed. Such a feature allows the system to establish time limits after which an application cannot be executed. This can be useful, for example, where access to an application is sought to be restricted to a particular time period for purposes of trial by a user, prior to purchase. If the key has expired as determined in step 315, then access, for further executions, is denied in step 320. Otherwise, the application is permitted to execute in step 325.

In general, the validity of an activation key can involve any of tests 307, 310, or 315, or other tests, or any combination thereof.

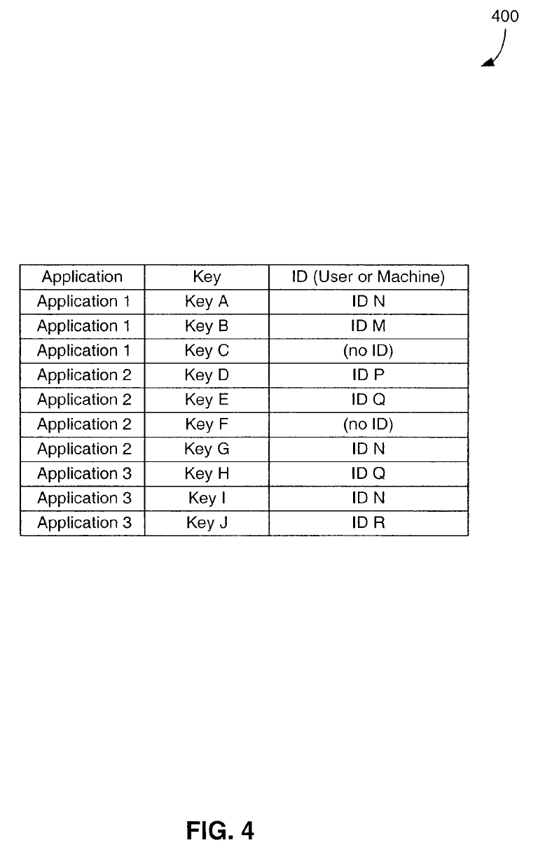

The structure of a mapping of activation keys to users or machines is illustrated logically in FIG. 4, according to an embodiment of the invention. Table 400 represents the mapping of activation keys A through J. These keys and this particular table are associated with one or more specific applications, shown here as applications 1-3. Key A is mapped to identification (ID) information N and application 1. As described above, in a given implementation, the identification information can be representative of a particular user. Alternatively, the identification information in the database can represent a particular client machine, such as client 105. Note that at any given time, not every activation key will necessarily be mapped to a particular identity. Key C, for example, is not mapped to any particular identification information. Key C will therefore be available for issuance to a new user seeking access to application 1.

In the illustrated embodiment, a single data structure is used, wherein applications are associated with particular keys and identification information. Moreover, additional parameters can also be stored in such tables.

In an embodiment of the invention, Table 400 is used to allocate activation keys, not to validate keys. As an example of key allocation, a client or user seeking access to application 2 will receive activation key F, since this is the next available key for application 2. If the machine or user seeks access to application 3, it is determined that no activation keys are available for this application. If the prevailing policy is that only one user, at most, holds a particular activation key, then the requesting user or machine is denied an activation key and thereby denied access to application 3.

### III. Information Overlay

The invention also includes a method and system by which information can be displayed to a user while minimizing disruption of the user's experience. The displayed information can include status or alert information, for example, pertaining to a download or other system activity. Alternatively, the displayed information can consist of advertising.

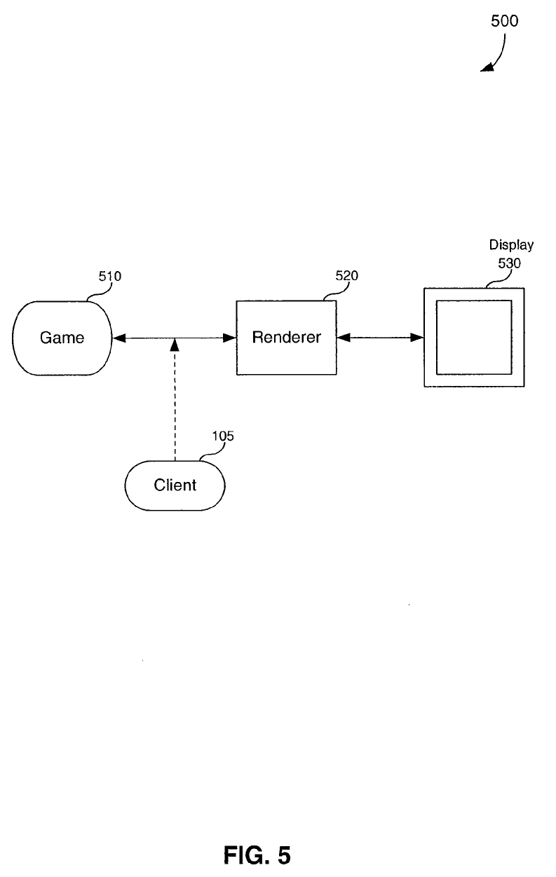

FIG. 5 illustrates generally how a renderer presents information to a user, where an application such as a game is being executed. A game 510 is shown in communication with a renderer 520. Through this connection, renderer 520 receives data and commands from game 510. The output of renderer 520 is then sent to a display 530. Here the user is shown the images presented by the game 510, allowing the user to provide input as necessary. The invention provides a system and method by which a client 105 can effectively insert itself between game 510 and renderer 520. This allows client 105 to provide information to the renderer 520, such as text and graphics, for display to the user on display 530. The provided information is overlaid on the normal game/application display.

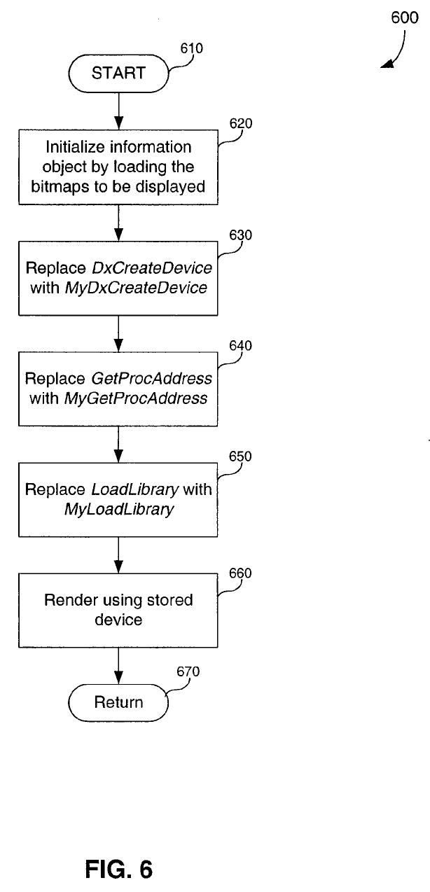

FIG. 6 illustrates a process by which client 105 can present the necessary data to the user. The process begins at step 610. In step 620, the client initializes an information object. This is done by loading a set of bitmaps that are to be displayed to the user.

At this point, the client needs to obtain access to the application programming interface (API). Moreover, access to the API needs to be retained by the client so that the appropriate message and/or graphics can be rendered for display to the user. Two or more processes, however, cannot have access (known as a “handle”) to the API at the same time. Here, the application, such as game 510, holds the handle to the API. The invention circumvents this problem in the following manner. In step 630, a hooking operation is performed, in which the device creation function is replaced with a client-created version of the device creation function. In the illustrated embodiment, the API is DirectX, and the device creation function is DxCreateDevice. Techniques for hooking are well known in the art, and include those described at www.codeguru.com/system/apihook.html, which is incorporated herein by reference in its entirety. In step 630, the DxCreateDevice function is replaced with the modified version, shown as MyDxCreateDevice, to effect hooking. The latter function serves to keep the DirectX device after a call to DxCreateDevice, so that the handle can be used subsequently. In step 640, a related process takes place in which the get process address function, GetProcAddress, is replaced with a variation, shown as MyGetProcessAddress. The latter function obtains a process address, just as the original version does, except that MyGetProcessAddress returns an address that corresponds to MyDxCreateDevice. In step 650, the library loading function is replaced with a variation referenced in the illustration as MyLoadLibrary. The latter function replaces, in the loaded module, the address of DxCreateDevice with that of MyDxCreateDevice. The previous function, LoadLibrary, is then called. After steps 630 through 650 are performed, the new functions are executed, and the handle to the API is secured. At this point, in step 660, rendering can take place using the stored device. This allows the information object of step 620 to be displayed to the user on display 530.

Given that hooking has taken place, the process of rendering an image as an overlay takes place in the context of the normal display rendering process. Overlay rendering proceeds according to the following pseudocode, in an embodiment of the invention.

```
MyPeekMessageA/MyPeekMessageW
    {
        call original PeekMessage
        if (EventOn(NetworkActivityEvent)==TRUE)
        {
            if(ShouldRender)// Check with timeouts if we should render
now
            {
                if(Render( ))// Render using the device
we stored through MyCreateDevice
                {
                    UpdateTime( )
                }
                else
                {
                    //error
                    //nothing we can do
                }
            }
        }
        else
        {
            //Event is off- nothing to do -no network activity now...
        }
    }
```

This logic is used if rendering is to be performed using a peek message, which normally retrieves the next message from the queue in a Windows environment. Within the PeekMessage call (in the hook code), a determination is made as to whether the network activity state pertains to a network activity event. It is then determined whether the time is right for rendering the overlay (if(ShouldRender)). This is necessary in situations where, for example, the display involves a flashing or blinking component (such as an icon), such that timing must be taken into account. Rendering of the overlay can then take place, assuming that the timing is correct. Time parameters are then updated (UpdateTime( )), so that subsequent activity (e.g., subsequent overlay rendering) can be performed at the appropriate time. The application normally does rendering with the “call original PeekMessage” statement, and the hook code writes over the screen that was rendered by the application. If it is not time for overlay rendering, it means that if something was rendered before, it is being erased by the new rendering done by the application. After a timeout, the hook code will start rendering again. This causes, in this timing operation, a blinking result.

Blinking is not always present. If the rendered image is stable, and not erased, the above timing operation need not be used.

If rendering is not normally done using PeekMessage, a worker thread is used to perform the overlay. The worker thread logic below is generally analogous to the above pseudocode.

```
WorkerThread
{
    do
    {
        Result = WaitOnEvents(NetworkActivity, StopThreadEvent)
        Switch(Result)
        {
        case(NetworkActivity):
            if(ShouldRender)// Check with timeouts if we should render
now
            {
                if(Render( ))// Render using the device we stored
through MyCreateDevice
                {
                    UpdateTime( )
                }
                else
                {
                    // error
                    // nothing we can do
                }
            case(StopThreadEvent):
                break;
            } while(true)
        }
    }
```

Logic for performing the hooking operation is illustrated below, according to the embodiment of the invention. The overlay is referred to below as NetworkIndicator.

```
MyDirectDrawCreateEx// Implemented specifically for each DirectX
version
{
    Call original DirectDrawCreateEx
    Save the returned pointer
    Call NetworkIndicatorActivate
}
    Activation of the overlay process is illustrated below
according to an embodiment of the invention.
NetworkIndicatorActivate
{
Open a handle to events that indicate network activity (reading from
the network) According to the operating environment:
Hook PeekMessageA with MyPeekMessageA, same for
PeekMessageW, or start WorkerThread
}
```

### IV. Content Upgrade/Downgrade

The invention includes a method and system for distributing a modification to an application that has previously been provided to a client 105. Such a modification may be an upgrade, for example, that includes new or improved functionality. A modification may alternatively be a downgraded to a previous version. If an installed upgrade does not work on a machine as currently configured, for instance, a user may want to revert to an earlier version of the application, i.e., a downgraded version.

An obvious solution to the problem of distributing an application modification would be to download a new version of the entire application. This is not practical for a number of reasons. First, a complete download would take an inordinate amount of time and memory. Ideally, however, a modification would be implemented with minimal burden to the user. Moreover, a complete download of the upgraded or downgraded application might be redundant. Such modifications of an application are not necessarily comprehensive and may only address small portions of content. Transfer of anything more than the upgraded portions would be unnecessary.

In addition, some of the previously downloaded components of the application may have been modified by a user. This may have been done in order to accommodate a user's preferences, for example. A comprehensive download would overwrite all such preferences. The user would therefore be forced to re-enter his or her preferences. The invention avoids these problems by transferring to the client 105 only those portions of the modified application that are needed by client 105, while preserving any user-implemented modifications.

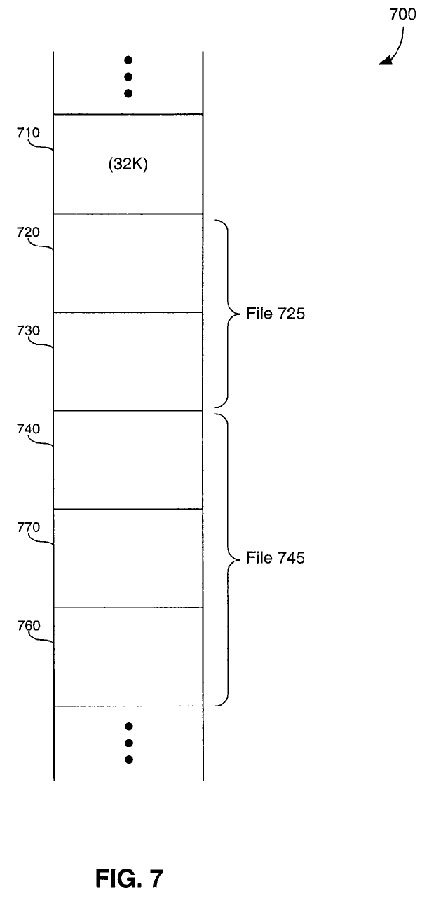

FIG. 7 illustrates how an image 700 of an application is typically stored at an application server 120. Image 700 is organized as a series of blocks, including blocks 710, 720, 730, 740, 750, and 760. As shown in block 710, in an embodiment of the invention, a block contains 32K bytes of data. Further, blocks can be organized into files. In the illustrated embodiment, file 725 is composed of blocks 720 and 730; file 745 is composed of blocks 740, 750, and 760.

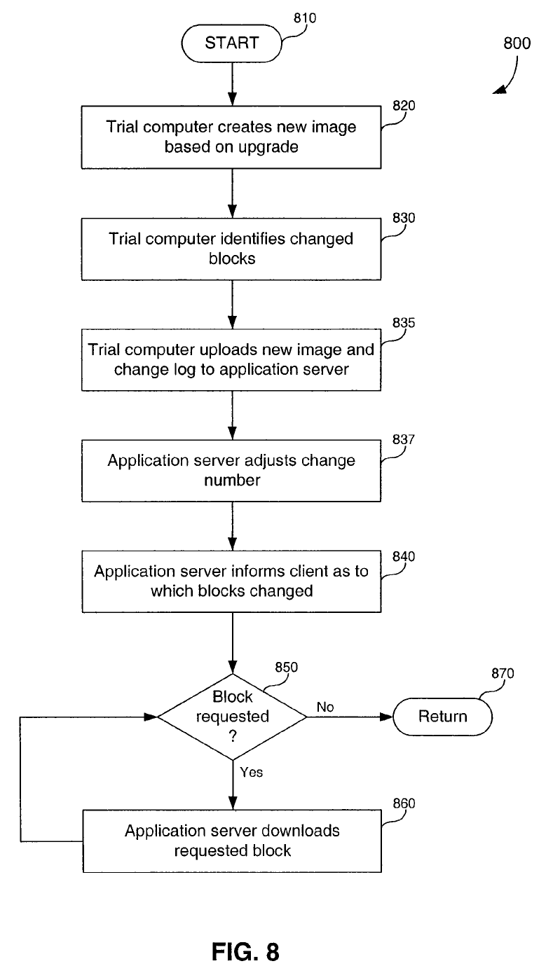

The overall process of modifying an application, from the perspective of the application server 120, is shown in FIG. 8. While the illustrated process concerns an upgrade, this process is presented as an example of an application modification; an analogous process can be used for a downgrade. The process begins at step 810. In step 820, a trial computer creates a new image based on the upgrade or downgrade of the application. In step 830, the trial computer identifies which blocks of the image 700 have changed in light of the modification, and lists identifiers for these blocks in a change log. In step 835, the trial computer uploads the new image and the change log to the application server 120. In step 837, the application server 120 adjusts a change number that corresponds to the current version of the application. If the application is being upgraded, the change number is incremented, for example.

In step 840, the application server informs the client 105 as to which blocks of the image have changed, by sending the change log to client 105. As will be described below, the application server 120 holds a log of identifiers of the respective changed blocks, and transmits this change log to the client 105. At this point, the application server 120 processes any requests from the client 105 for particular blocks of the image. Hence, in step 850, a determination is made at the application server 120 as to whether a block has been requested by the client 105. If so, in step 860, the application server 120 send the requested block to the client 105. The application server 120 then continues to process block requests as necessary.

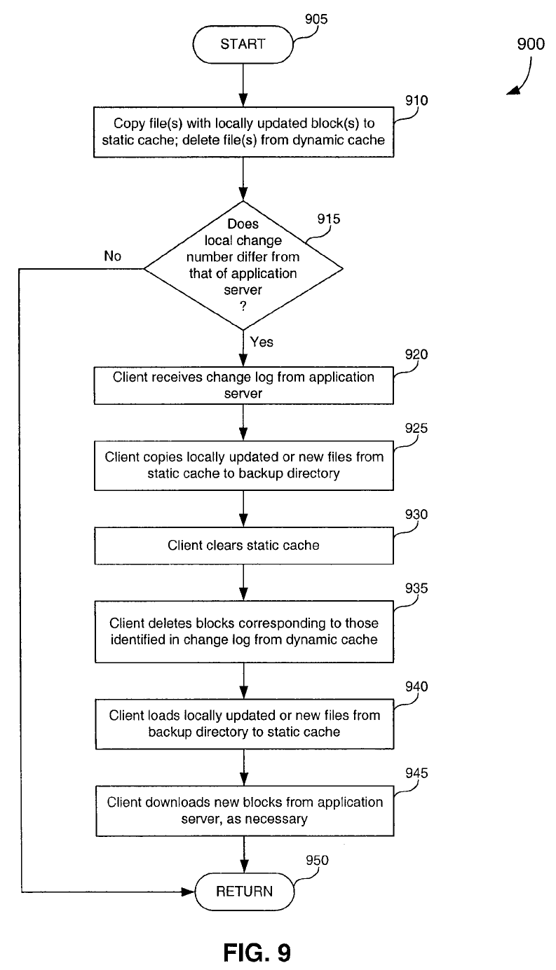

The upgrade process from the client perspective is illustrated in FIG. 9. Again, note that a downgrade process would proceed in an analogous fashion. The process begins at step 905. In step 910, given an application, any associated files that contain blocks updated locally at the client are moved to a static cache. The corresponding files are deleted from a dynamic cache. The static and dynamic caches are described in greater detail below. In step 915, a determination is made as to whether the change number of the application stored at the client differs from the change number of the application as stored at the application server. If not, then the client's version of the application is the same as that of the version stored at the application server. In this case, no upgrade is necessary, and the process concludes at step 950.

If, however, the change numbers differ, then the process continues at step 920. Here, the client 105 receives a change log from the application server. The change log represents a list of blocks that have been changed at the application server as a result of the upgrade. In step 925, the client 105 copies any locally updated or new files from the static cache to a backup directory. In step 930, the client clears the static cache.

In step 935, the client 105 deletes blocks from the dynamic cache. In particular, the client deletes those blocks that correspond to the blocks identified in the change log. In step 940, client 105 loads the locally updated or new files from the backup directory back to the static cache. In step 945, the client downloads upgraded blocks from the application server, as needed. The process concludes at step 950.

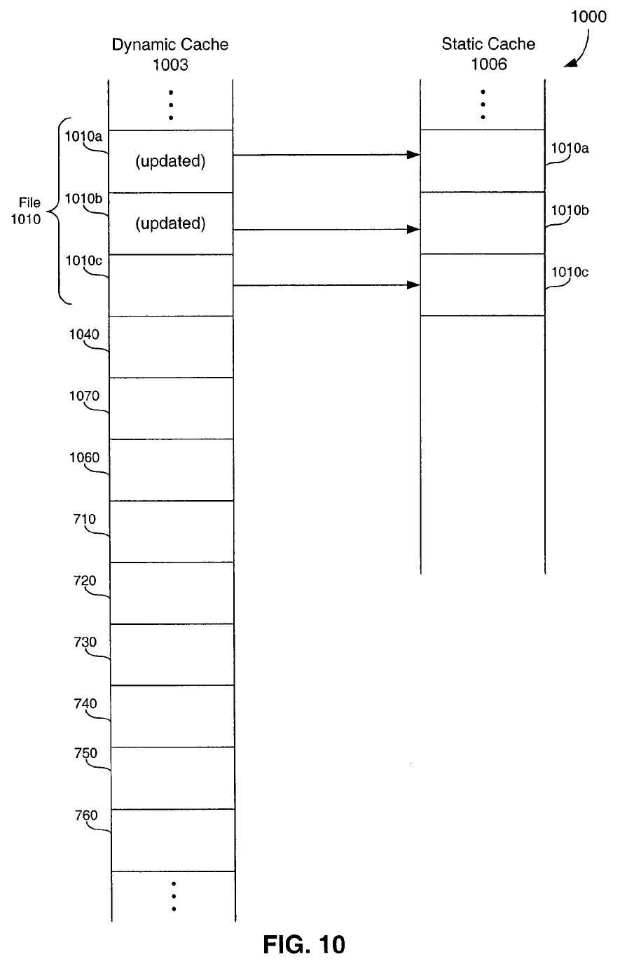

FIG. 10 illustrates the storage of locally updated blocks to a static cache. A dynamic cache 1003 is illustrated along with a static cache 1006. Dynamic cache 1003 initially holds a file 1010 which is comprised of blocks 1010a, 1010b, and 1010c. Dynamic cache 1003 also includes blocks 1040, 1050, 1060, 710, 720, 730, 740, 750, and 760.

Over time, the client 105 may update certain files that relate to a given application. Specific blocks in a file may be updated, for purposes of instituting user preferences, for example. In the example of FIG. 10, block 1010a has been updated and the updated version is loaded into static cache 1006. Likewise, block 1010b has also been updated and loaded into static cache 1006. Given that there are blocks in file 1010 in addition to those that have been updated, the remaining blocks of file 1010 are also transferred to static cache 1006. For this reason, block 1010c is moved from dynamic cache 1003 to static cache 1006, even though block 1010c has not been updated by the client. This is done in order to maintain a consistent file in the static cache in case the same file is updated during content update.

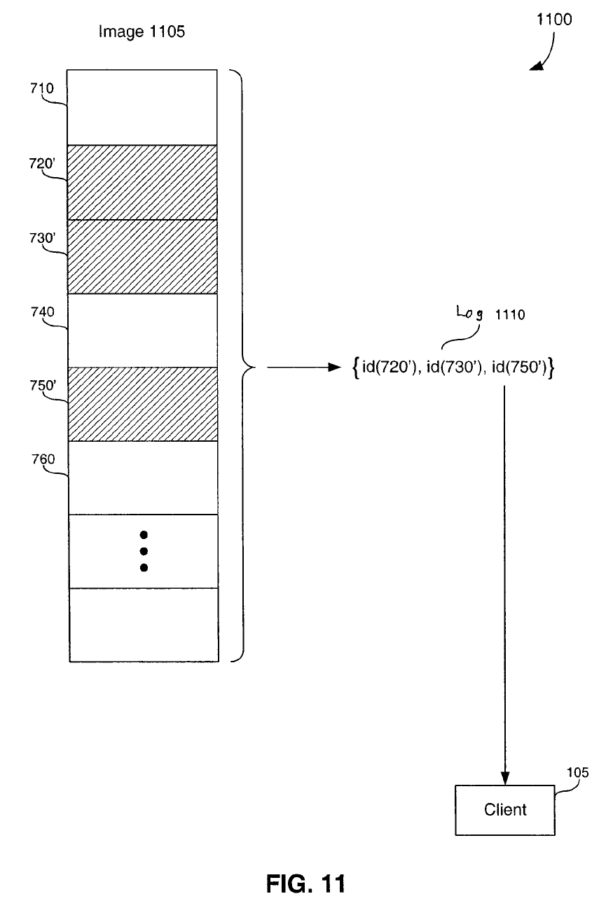

The process of creating and transferring a change log from an application server to a client is illustrated in FIG. 11. An image 1105 of an application is shown in FIG. 11 containing three blocks that have been changed in a recent upgrade. The changed blocks are blocks 720′, 730′ and 750′. A list of these changed blocks is then created and illustrated as log 1110. Log 1110 includes identifiers for each of the three changed blocks. This list is then transferred to client 105.

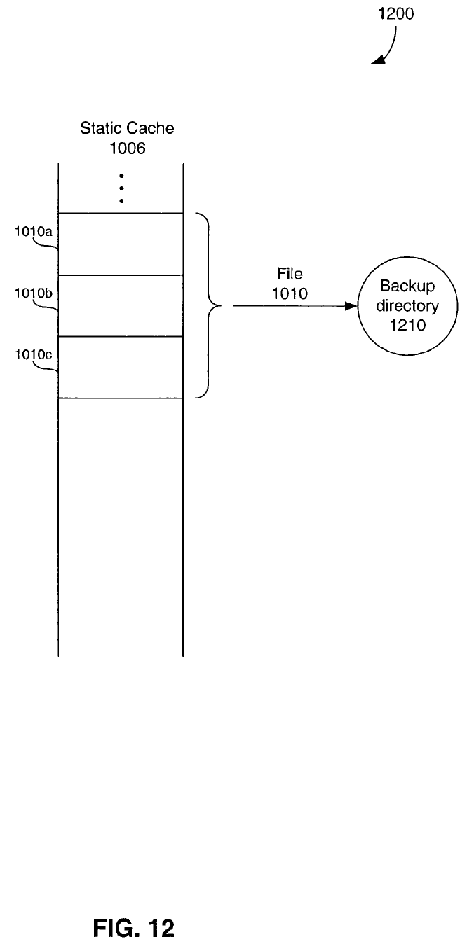

The process of transferring locally updated files to a backup directory is illustrated in FIG. 12. Static cache 1006 is shown, holding blocks 1010a, 1010b, and 1010c. Blocks 1010a and 1010b are blocks that have been updated locally by the client. Nonetheless, all the blocks of file 1010 are transferred to a backup directory 1210.

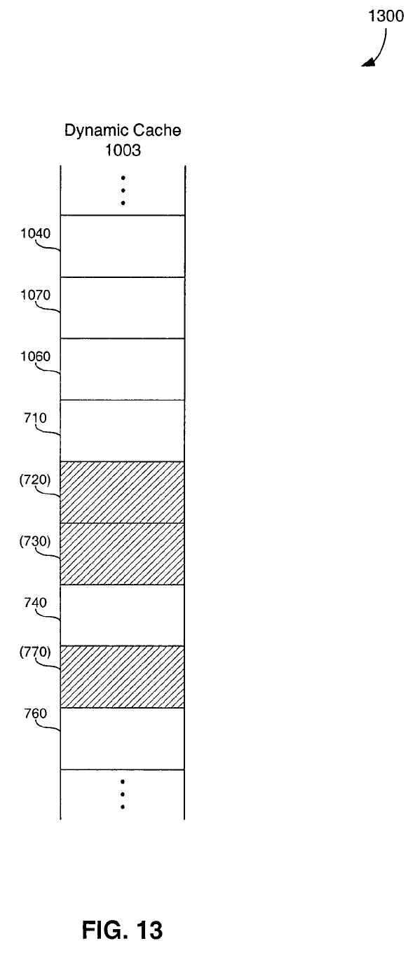

The modification of dynamic cache 1003 in response to receipt of a change log is illustrated in FIG. 13. Recall that dynamic cache 1003 had included blocks 720, 730, 750. The change log 910 received from the application server serves to convey to the client 105 that blocks 720, 730, and 750 have been upgraded. The corresponding blocks 720, 730, and 750, are therefore deleted from dynamic cache 1003.

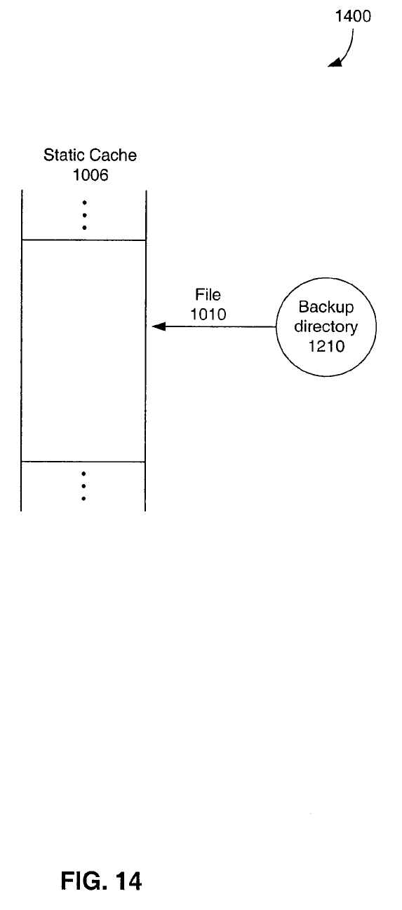

FIG. 14 illustrates the process of reloading file 1010 from the backup directory to the static cache. Recall that file 1010 contains blocks that were updated locally by the client 105. File 1010 is shown being restored to static cache 1006 from backup directory 1210. This serves to retain any client-created updates to the application.

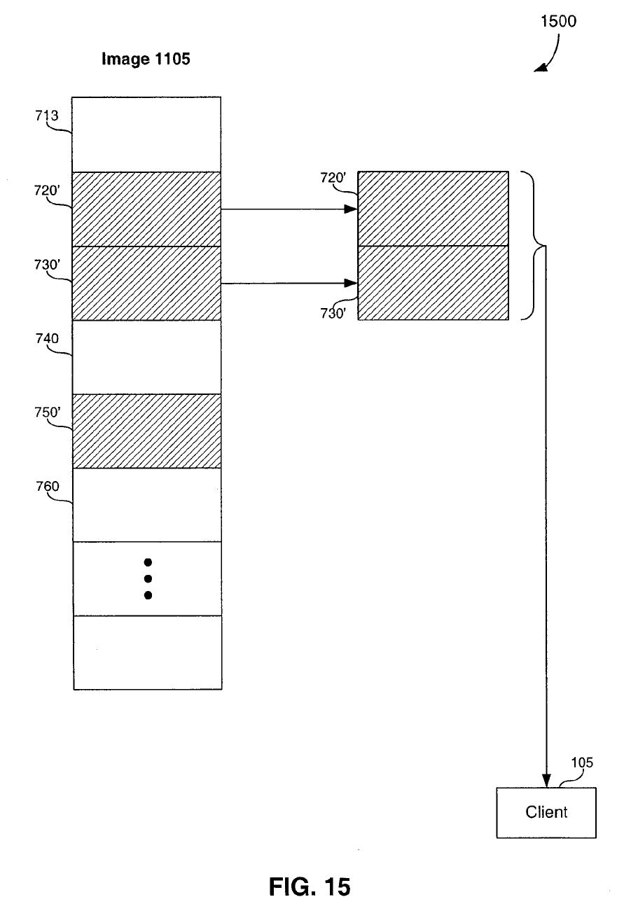

FIG. 15 illustrates the transfer of upgraded blocks from an application server 120 to client 105. As discussed above with respect to FIG. 9, image 905, after upgrading, includes upgraded blocks 720′, 730′ and 750′. Some or all of these blocks are transferred from image 905 at application server 120 to client 105. In the example shown, client 105 has requested blocks 720′ and 730′. These blocks are then transferred to client 105.

Optimization of the application upgrade or downgrade process can be performed when there are changes only to the content metadata. In such a case, there is no need to export and import files into a temporary directory; rather, the metadata is simply updated.

In any such upgrade or downgrade of an application, the registry can be upgraded as well. Similar to the application upgrade, local changes to the registry must be maintained. One way of accomplishing a registry upgrade is to copy the upgraded registry from the server to the client. The local registry (containing any locally made changes to the registry) is copied into the registry hive. This maintains the local registry changes. A downgrade of the registry would proceed similarly.

### V. Disk Caching

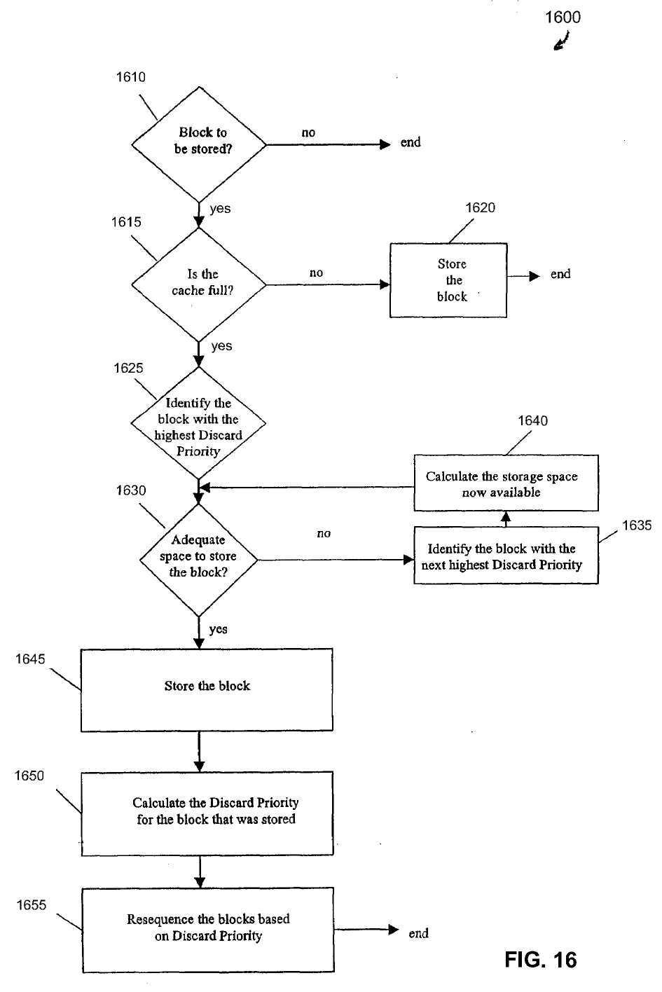

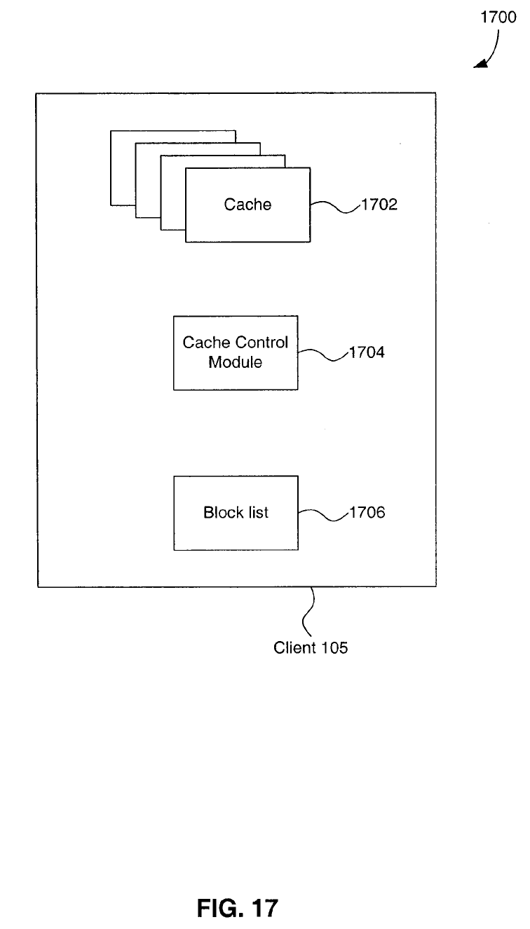

The invention also provides for the efficient caching of blocks of information on the hard drive of a local client computer 105. One embodiment of the invention (illustrated in FIG. 17) features a Least Recently Least Frequently Used (LRLFU) method for efficient caching, performed by a cache control module 1704 executing on client 105. FIG. 16 is a flow chart diagram illustrating the sequence of steps used to cache a block of information, in accordance with an embodiment of this invention.

A storage space is allocated to provide a cache 1702 in memory (e.g., the hard drive) for cached blocks of information to be stored on the client computer 105. In one embodiment, the storage space is allocated prior to the caching of the first block of information. In another embodiment, the storage space is allocated simultaneously with the caching of the first block of information.

The invention may allocate different caches for different work sessions. When a block of information is to be stored (step 1610), the cache 1702 (or storage space) is checked to determine whether sufficient memory space exists for the block (step 1615). If there is sufficient space, the block is stored for use (step 1620) and the method is finished for that block. If there is not sufficient room in the cache 1702 to store the block, the block with the highest discard priority is identified (step 1625). A determination is made as to whether removal of the block with the highest discard priority will provide sufficient space to store the incoming block (step 1630). If insufficient space is available, the block of information with the next-highest discard priority is identified (step 1635), and the amount of storage space to be provided by removal of both of these blocks is calculated (step 1640). The cycle of steps 1630, 1635, and 1640 is repeated until sufficient storage is identified for the incoming block. The block is then stored (step 1645) in the space occupied by the blocks identified above, and a discard priority for the newly stored block is calculated (step 1650). The listing of the blocks is then sorted in order of descending discard priority (step 1655). This process is repeated for each subsequent block of information to be cached.

A more particularized description of these method steps is found in the paragraphs that follow, including samples of underlying mathematical calculations that can be used to calculate the discard priority.

In addition, blocks of information for various content (e.g., various applications) are used in multiple sequential work sessions. Blocks of information are retained in a cache 1702 on the hard drive of the client computer 105, based on the likelihood of their being used in the future. This reduces the number of retrieval operations required to obtain these blocks of information from other data sources. Reducing the retrieval requirements from these slower sources results in improved efficiency, faster responses, and an enhanced user experience for the operator of the client computer 105.

Another feature of the LRLFU method is that blocks of information cached for a given content are not discarded at the end of the work session. Rather than abandoning the blocks of information cached for an application at the conclusion of a work session, the cache contents are retained. They are then available for a subsequent work session using the same content, provided the prior work session has finished. This persistent caching of blocks of information reduces the amount of information a subsequent work session will need to obtain from the data source. The eventual elimination of the persistently cached blocks does not occur until their discard priority becomes sufficiently high to warrant replacing them with different blocks of information.

The discard priority of each block is used to determine which of them are least likely to be required in the future. When additional space for a new block of information is needed in the cache, the LRLFU method (executed by the cache control module 1704) discards the block with the highest discard priority to make room for the new block. The block discarded can be from the cache of the present work session, the cache of an inactive work session of a different content, or from the cache of a concurrently active work session of a different content.

Determination of the discard priority for each block of information contained in a cache represents an important aspect of this invention. Its determination is predicated on some general assumptions. When calculating the discard priority for a block of information, it is likely that if that block was required in a prior work session, it will also be needed in a subsequent work session of the same content. Accordingly, continued caching of this block of information on the hard drive of the client computer 105 reduces the likelihood of having to obtain it from a different and slower source in the future. Likewise, a block of information should be assigned a lower discard priority if it is accessed multiple times during a work session. Frequent access to the block during the current work session or prior work sessions is an indication it will be frequently accessed in the next work session of that content. Finally, if the prior work session was chronologically close in time to the present session, the common range of information used by the two sessions is likely to be larger. Calculation of the block discard priority reflects these assumptions.

For calculation of the discard priority of a block, the cache for the work session of content comprises several attributes. First, storage space is allocated to provide for the existence of the cache in memory (e.g., the hard drive of the client computer 105) as described above. Moreover, the cache has a specific size initially, although the size of the cache for different contents can vary. However, the cache size of each work session can be dynamically adjusted. After the cache has become full, a new block of information is written to the storage location of the cached block with the highest discard priority, effectively deleting the old block. The block deleted may have been stored for the present work session, the work session of content that is now inactive, or the active work session of another content. The block to be deleted is selected based on its discard priority. This provides for the dynamic adjustment of the cache space available for each content being used, based on the discard priority calculation results.

Dynamic adjustment of the amount of storage space allocated to a cache may also be achieved by manual intervention. For example, if a user wishes to decrease the amount of storage space allocated for a cache, the LRLFU method removes sufficient blocks of information from the cache to achieve the size reduction. The blocks to be removed are determined based upon their discard priority, thereby preserving within the cache the blocks most likely to be used in the future.

In addition to the size of the cache, the Global Reference Number and the Head-of-the-List block identification location represent two more attributes of the cache for each work session. The Global Reference Number is reset to zero each time a work session is started, and is incremented by one each time the cache is accessed. The Head-of-the-List block identification location indicates the identity of the block in the cache of the work session that possesses the highest discard priority. In other embodiments of the invention, it can be used to indicate the identity of the block with the highest discard priority as selected from the current work session, any inactive work sessions, and/or any other active work sessions.

Likewise, each block contained within the cache of a work session has certain attributes that are used in calculating its discard priority. Each block has associated with it (for example, as an array) a Reference Number, plus up to m entries in a Reference Count array. The Reference Number of a block is set equal to the value of the Global Reference Number each time that block is accessed. This value is stored as the Reference Number of that block. The block Reference Numbers can be used to sort them in the order in which they have been accessed.

The m entries of the Reference Count array for each block represent the number of times that block was accessed in each of the previous m work sessions. The present session is identified as session 0, the prior session is identified as session 1, and so forth. Up to m entries in the Reference Count array are stored for a given block. The value stored in the Reference Count array for each session represents how many times that block was accessed during that session. By using the Reference Number and the Reference Count array values for a given block, its discard priority can be calculated as discussed below.

Initialization of the above-identified parameters is performed as follows. When the client computer 105 is booted up, the Reference Number and Reference Count array values are set to zero. When a work session is started, the Global Reference Number for the cache associated with that work session is set to zero, and the Reference Count values for each block in the array are shifted one place, discarding the oldest values at position m−1 (the position that is assigned to session m). The Reference Count values for session 0 (the present session) start at zero and are incremented by one each time the block is accessed.

These values are used by the LRLFU method to calculate the discard priority. The discard priority of a block is calculated each time it is accessed. After the Discard Priority has been calculated, the list of blocks 1706 is sorted in descending order based on the discard priority calculated. The block with the highest discard priority is at the top of the sorted list, and its identity is indicated in the Head-of-the-List block identification location. It is the first block to be discarded when additional space is required in the cache.

The discard priority of a block is determined based on a calculated weighted time factor (Tw) and a weighted frequency factor (Fw). They are used as follows:

Block Discard Priority=N1*1/((1+Tw)×Fw)

and calculated by the following formulae:

Tw=P1*(Block Reference number/Global Reference Number)

Fw=P2*Σₘ(RefCount[m]/2^{m})

In these equations, N1 represents a normalization factor and is set to a fixed value that causes the result of the equation to fall within a desired numerical range. P1 and P2 are weighting factors. They are used to proportion the relative weight given to the frequency factor (Fw) as compared with the time factor (Tw), to achieve the desired results.

The time factor (Tw) is proportional to the time of last access of the block within the work session. If the block has not been accessed during the current work session, the time factor is zero. If the block was recently accessed, the time factor has a value approaching P1 times unity.

The frequency factor (Fw) represents the number of times the block has been accessed during the current session (session number 0) through the m^{th} session (session number m−1). These are summed up and discounted based on the age of the prior work session(s). In the above equation, the discounting is performed by the factor 2^{m}, where m represents the session number corresponding to the Reference Count array value for that block of information. Other discounting factors can be used for this purpose. Greater discounting of older work session Reference Count array data can be accomplished by using factors such as 2^{2m}, or 2^{mm}, etc., in place of 2^{m}. Alternatively, discounting of the older work session Reference Count array data could be reduced, for example, by using a discounting factor of 1.5^{m} or the like, in place of 2^{m}, thereby more strongly emphasizing the Reference Count array values of the older work sessions for each block.

Block Discard Priorities can be calculated using the results of the above calculations. These are calculated for a block of information each time it is accessed from the cache 1702. After the discard priority has been calculated, the listing of the blocks 1706 is resequenced and the block with the highest discard priority is positioned at the top of the list. The identity of this block is placed in the Head-of-the-List block identification location. It then becomes the next block to be discarded when additional cache space is required. Should the space required for the incoming block of information be greater than what was freed up, then the block of information with the next highest discard priority is also discarded, and so on. By this method sufficient room is created for the incoming block of information.

Operating in this manner, the LRLFU method provides for efficient utilization of the storage space allocated for the caching of blocks of information for a given work session of a content. This is done by discarding the block with the highest discard priority, as calculated by the LRLFU method, to methodically create room for the new blocks to be cached for the ongoing work session. The blocks discarded are those least likely to be needed in the future, based on when they were last accessed and how often they have been used in prior work sessions. At completion of the work session the cache is not cleared, but the blocks of information and their corresponding priority information are retained for use with subsequent work sessions of that content. Since the cache is not cleared at the termination of the work session, the method also provides for the persistent storage of the blocks of information most likely to be needed by present or future work sessions of a given content. This results in improved performance, increased efficiency, and an enhanced user experience.

By utilizing the above method and adjusting the parameters identified and explained, improved utilization of the hard drive space available for caching can be performed.

### VI. Computing Context

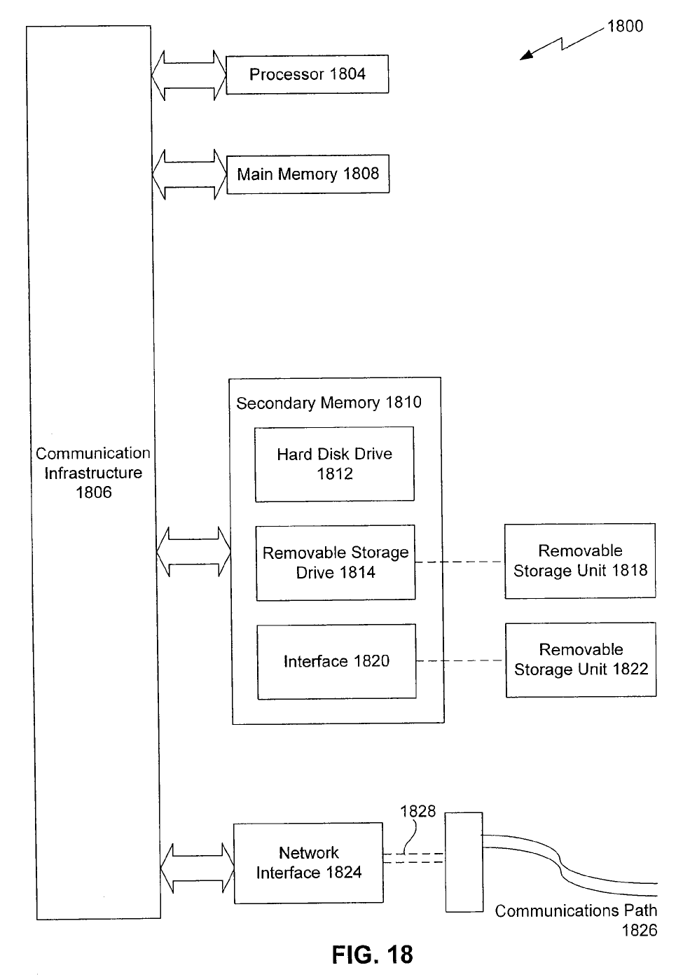

The logic of the present invention may be implemented using hardware, software or a combination thereof. In an embodiment of the invention, the above processes are implemented in software that executes on application server 120, client 105, and/or another processor. Generally, each of these machines is a computer system or other processing system. An example of such a computer system 1800 is shown in FIG. 18. The computer system 1800 includes one or more processors, such as processor 1804. The processor 1804 is connected to a communication infrastructure 1806, such as a bus or network. After reading this description, it will become apparent to a person skilled in the relevant art how to implement the invention using other computer systems and/or computer architectures.

Computer system 1800 also includes a main memory 1808, preferably random access memory (RAM), and may also include a secondary memory 1810. The secondary memory 1810 may include, for example, a hard disk drive 1812 and/or a removable storage drive 1814. The removable storage drive 1814 reads from and/or writes to a removable storage unit 1818 in a well known manner. Removable storage unit 1818 represents a floppy disk, magnetic tape, optical disk, or other storage medium which is read by and written to by removable storage drive 1814. The removable storage unit 1818 includes a computer usable storage medium having stored therein computer software and/or data.

In alternative implementations, secondary memory 1810 may include other means for allowing computer programs or other instructions to be loaded into computer system 1800. Such means may include, for example, a removable storage unit 1822 and an interface 1820. Examples of such means may include a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communications interface 1824. Communications interface 1824 allows software and data to be transferred between computer system 1800 and external devices. Examples of communications interface 1824 may include a modem, a network interface (such as an Ethernet card), a communications port, a PCMCIA slot and card, etc. Software and data transferred via communications interface 1824 are in the form of signals 1828 which may be electronic, electromagnetic, optical or other signals capable of being received by communications interface 1824. These signals 1828 are provided to communications interface 1824 via a communications path (i.e., channel) 1826. This channel 1826 carries signals 1828 and may be implemented using wire or cable, fiber optics, a phone line, a cellular phone link, an RF link and other communications channels.

In this document, the terms “computer program medium” and “computer usable medium” are used to generally refer to media such as removable storage units 1818 and 1822, a hard disk installed in hard disk drive 1812, and signals 1828. These computer program products are means for providing software to computer system 1800.

Computer programs (also called computer control logic) are stored in main memory 1808 and/or secondary memory 1810. Computer programs may also be received via communications interface 1824. Such computer programs, when executed, enable the computer system 1800 to implement the present invention as discussed herein. In particular, the computer programs, when executed, enable the processor 1804 to implement the present invention. Accordingly, such computer programs represent controllers of the computer system 1800. Where the invention is implemented using software, the software may be stored in a computer program product and loaded into computer system 1800 using removable storage drive 1814, hard drive 1812 or communications interface 1824.

### VII. Conclusion

While some embodiments of the present invention has been described above, it should be understood that it has been presented by way of examples only, and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents. Each document cited herein is hereby incorporated by reference in its entirety.

What is claimed is:

1. A method for overlaying information on an application display, comprising:
executing an application, wherein the application accesses an application programming interface (API) of one or more graphic libraries to render graphics associated with the application to a display; and
during execution of the application:
obtaining access to the API from the application on behalf of a logic component, and
using the API on behalf of the logic component to overlay an information object onto the graphics associated with the application and to render the graphics associated with the application and the overlaid information object to the display.

2. The method of claim 1, wherein the application is a video game.

3. The method of claim 1, wherein the information object comprises an advertisement.

4. The method of claim 1, wherein the one or more graphic libraries comprises a version of DirectX.

5. The method of claim 1, wherein the one or more graphic libraries comprises a version of OpenGL.

6. The method of claim 1, wherein the logic component executes as part of a process associated with the application.

7. The method of claim 1, wherein the logic component executes outside of a process associated with the application.

8. The method of claim 1, further comprising:
initializing the information object by determining and loading a set of graphic assets that may be subsequently displayed to a user.

9. The method of claim 1, wherein obtaining access to the API from the application on behalf of the logic component comprises hooking function calls from the application to the API.

10. The method of claim 9, wherein hooking function calls from the application to the API comprises one or more of:
replacing an original device creation function associated with the API with a customized version of the original device creation function;
replacing an original function for obtaining a process address associated with the API with a customized version of the original function for obtaining a process address; and
replacing an original library loading function associated with the API with a customized version of the original library loading function.

11. The method of claim 1, wherein the step of using the API on behalf of the logic component to overlay an information object onto the graphics associated with the application and to render the graphics associated with the application and the overlaid information object to the display is performed responsive to the detection of an input/output (I/O) event.

12. The method of claim 11, wherein the I/O event is a network activity event.

13. A system for overlaying information on an application display, comprising:
an application programming interface (API) associated with one or more graphics libraries configured to render graphics to a display;
an application configured to access the API to render graphics associated with the application to the display; and
a logic component configured to obtain access to the API from the application during execution of the application and to use the API to overlay an information object onto the graphics associated with the application and to render the graphics associated with the application and the overlaid information object to the display.

14. The system of claim 13, wherein the application is a video game.

15. The system of claim 13, wherein the information object comprises an advertisement.

16. The system of claim 13, wherein the one or more graphics libraries comprise a version of DirectX.

17. The system of claim 13, wherein the one or more graphics libraries comprise a version of OpenGL.

18. The system of claim 13, wherein the logic component is further configured to initialize the information object by determining and loading a set of graphic assets that may be subsequently displayed to a user.

19. The system of claim 13, wherein the logic component is configured to obtain access to the API from the application by hooking function calls from the application to the API.

20. The system of claim 13, wherein the logic component is configured to hook function calls from the application to the API by performing one or more of:
replacing an original device creation function associated with the API with a customized version of the original device creation function;
replacing an original function for obtaining a process address associated with the API with a customized version of the original function for obtaining a process address; and
replacing an original library loading function associated with the API with a customized version of the original library loading function.

21. The system of claim 13, wherein the logic component is configured to use the API to overlay an information object onto the graphics associated with the application and to render the graphics associated with the application and the overlaid information object to the display responsive to the detection of an input/output (I/O) event.

22. The system of claim 21, wherein the I/O event is a network activity event.

23. A logic component, comprising:
logic configured to obtain access to an application programming interface (API) to one or more graphics libraries from an application during execution of the application;
logic configured to use the API to overlay an information object onto graphics associated with the application and to render the graphics associated with the application and the overlaid information object to a display.

24. The logic component of claim 23, wherein the application is a video game.

25. The logic component of claim 23, wherein the information object comprises an advertisement.

26. The logic component of claim 23, wherein the one or more graphics libraries comprises a version of DirectX.

27. The logic component of claim 23, wherein the one or more graphics libraries comprises a version of OpenGL.

28. The logic component of claim 23, further comprising:
logic configured to initialize the information object, wherein the logic configured to initialize the information object includes logic configured to determine and load a set of graphic assets that may subsequently be displayed to a user.

29. The logic component of claim 23 wherein the logic configured to obtain access to the API from the application during execution of the application comprises:
logic configured to hook function calls from the application to the API.

30. The logic component of claim 29, wherein the logic configured to hook function calls from the application to the API comprises one or more of:
logic configured to replace an original device creation function associated with the API with a customized version of the original device creation function;
logic configured to replace an original function for obtaining a process address associated with the API with a customized version of the original function for obtaining a process address; and
logic configured to replace an original library loading function associated with the API with a customized version of the original library loading function.

31. The logic component of claim 23, wherein the logic configured to use the API to overlay an information object onto the graphics associated with the application and to render the graphics associated with the application and the overlaid information object to the display comprises:
logic configured to detect an input/output (I/O) event; and
logic configured to use the API to overlay the information object onto the graphics associated with the application and to render the graphics associated with the application and the overlaid information object to the display responsive to the detection of the I/O event.

32. The logic component of claim 31, wherein the I/O event is a network activity event.
